(19) United States
(12) Patent Application Publication
(10) Pub. No.: US 2020/0050874 A1
(43) Pub. Date: Feb. 13, 2020

(54) CAR INTERIOR SURVEILLANCE SYSTEM WITH E-CALL FUNCTIONALITY

(71) Applicant: IEE INTERNATIONAL ELECTRONICS & ENGINEERING S.A., Echternach (LU)

(72) Inventors: Holger LORENZ, Bernkastel (DE); Martin THINNES, Trierweiler (DE); Thierry GONIVA, Luxembourg City (LU)

(21) Appl. No.: 16/336,017

(22) PCT Filed: Sep. 18, 2017
(86) PCT No.: PCT/EP2017/073440

§ 371 Date: Mar. 22, 2019

(30) Foreign Application Priority Data
Sep. 23, 2016 (LU) 93 233

(51) Int. Cl. G06K 9/00; B60W 50/00

(52) U.S. Cl. CPC G06K 9/00832; B60W 2050/0078; B60W 2050/0079; B60W 50/0098

(57) ABSTRACT

A car interior surveillance unit includes a detection unit for detecting a presence of a living human being or a living animal being in the passenger cabin of a car, a telecommunication unit for establishing a wireless telecommunication link to a remote telecommunication participant, an electric power supply unit including at least one rechargeable battery for providing electric power in at least one operational mode of the car interior surveillance unit, an electric power monitoring device for monitoring a presence of electric power at the electrical connection point and an electronic control unit that is configured for controlling operation of at least the detection unit and the telecommunication unit at least on the basis of a detected absence of electric power at the electrical connection point and a detected presence of a living human being or a living animal being in the passenger cabin.

### TECHNICAL FIELD

The invention relates to a car interior surveillance unit, a method of operating such car interior surveillance unit and a software module for controlling an execution of steps of the method.

### BACKGROUND OF THE INVENTION

From prior art it is known to use car interior surveillance systems for the purpose of controlling operational parameters of car subsystems, such as, for example, an activation control for an auxiliary restraint system (ARS) comprising air bags. The car interior surveillance systems can employ sensors of different types.

For instance, international application WO 2003/002366 A1 describes a method and a device for influencing at least one parameter on a vehicle, by which the active and passive safety of the occupants can be improved. Vehicle surroundings are monitored for the occurrence of a relevant event and a vehicle interior is monitored, for example by a video device, for the set position of at least one vehicle occupant. On occurrence of the at least one relevant event and recognition of the set position, signals corresponding to the event and the set position are fed to an analytical unit. The analytical unit triggers at least one active and/or passive safety system of the vehicle, depending on the at least one recognized relevant event and the recognized set position of the at least one person.

European patent application EP 2 746 805 A1 describes an ultrasound interior space monitoring system for a motor vehicle. The monitoring system includes at least one ultrasound transmitter and at least one ultrasound receiver that can be attached in the interior space of the motor vehicle and that are configured for the contactless monitoring of the interior space.

International application WO 2000/38949 A2 describes a system to identify, locate and monitor occupants, including their parts, and other objects in the passenger compartment and objects outside of a motor vehicle by using one or more lenses to focus images of the contents onto one or more arrays of charge coupled devices (CCD's) or CMOS arrays for controlling a deployment of airbags.

A microwave-based detection system using 24 GHz low-power radio waves for detecting children that are left in vehicles is commercially available at present (www.iee.lu/en/products/automotive/vitasense). The detection system provides information about a detected occupant to vehicle warning systems. It detects occupants, including newborns, based on their movements or breathing—even when they are sleeping.

As an unaddressed aspect of car interior surveillance, child and pet protection is identified in the present application. Every year, a large number of children die from heatstroke after being left in locked cars. All it takes is a change in the daily routine which distract the parent or caregiver, in particular when the child is ‘out of sight’ on the rear seat of the car, or there is a misunderstanding between parents about who will take the child out of the car. Another possible scenario is a child climbing into an unlocked car.

The interior temperature of a car can reach a critical level in 15 minutes. As children are affected by heatstroke faster than adults, the result can be lethal. A similar situation exists for pets. It is desirable to provide a remedy for this potential problem.

### OBJECT OF THE INVENTION

It is therefore an object of the invention to provide a car interior surveillance unit that is capable to automatically call and alert helpers in the above-described potentially critical situations.

### GENERAL DESCRIPTION OF THE INVENTION

In one aspect of the present invention, the object is achieved by a car interior surveillance unit comprising a detection unit, a telecommunication unit, an electric power supply unit, an electric power monitoring device and an electronic control unit.

The detection unit includes detection means for detecting a presence of a living human being or a living animal being in the passenger cabin of a car. The telecommunication unit includes telecommunication means for establishing a wireless telecommunication link to a remote telecommunication participant. The electric power supply unit comprises at least one rechargeable battery for providing electric power in at least one operational mode of the car interior surveillance unit. The electric power supply unit further includes a battery charging unit that is electrically connectable to an electrical connection point of the on-board electrical voltage of the car for charging the at least one rechargeable battery. The electric power monitoring device is configured for monitoring a presence of electric power at the electrical connection point. The electronic control unit includes a processor unit and a digital data memory unit to which the processor unit has data access.

The electronic control unit is configured for controlling operation of at least the detection unit and the telecommunication unit at least one the basis of
a detected absence of electric power at the electrical connection point, and
a detected presence of a living human being or a living animal being in the passenger cabin.

The term “remote telecommunication participant”, as used in this application, shall in particular encompass any telecommunication participant that is located outside the car passenger cabin.

The phrase “being configured to”, as used in this application, shall in particular be understood as being specifically programmed, laid out, furnished or arranged.

In a suitable configuration, the proposed car interior surveillance unit can provide the option to automatically call external help, for instance rescue workers, in cases of living human beings or pets being trapped or forgotten in the passenger cabin.

Preferably, in at least one operational mode, the electronic control unit is configured for controlling operation of the telecommunication unit to establish wireless telecommunication link to a remote telecommunication participant upon occurrence of a combination of a detection of absence of electric power at the electrical connection point and detection of a presence of a living human being or a living animal being in the passenger cabin.

Preferably, the telecommunication means is selected from a group comprising, but not being limited to, a GSM (Global System for Mobile Communications) module including modules that are capable of using EDGE (Enhanced Data Rates for GSM Evolution), GPRS (General Packet Radio Service) and UMTS (Universal Mobile Telecommunications System), a Bluetooth® module, a WLAN (wireless local area network) module, and an LTE(-Advanced) (Long-Term Evolution) module.

Further preferably, the detection means is selected from a group comprising, but not being limited to, an optical digital single-shot or video camera for visible light and an electronic motion detector device comprising at least one sensor out of a passive infrared light sensor, a microwave (e.g. Doppler) sensor and an ultrasonic sensor.

In a preferred embodiment, the car interior surveillance unit further comprises an illumination unit, for serving as an interior light, which is connectable to the electrical connection point of the on-board electrical voltage of the car. The illumination unit may be configured to emit light in the visible spectrum and/or in the infrared spectrum into the car interior. Moreover, the car interior surveillance unit includes a housing for at least partially covering the balance of the car interior surveillance unit towards the car interior. The housing has a mechanical interface that is configured to mechanically engage with a corresponding mechanical interface arranged in the vicinity of the electrical connection point.

In this way, the car interior surveillance unit can readily be retrofitted by replacing a conventional rear interior light.

If the electrical connection point of the on-board electrical voltage of the car is formed by an electrical connection point of the car that is intended to supply electric power to a conventional rear interior light arranged at the interior roof top of the car, the detection means can be positioned at a location that is close to an optimum for surveillance of the rear portion of the passenger cabin.

In some embodiments, the car interior surveillance unit further comprises a global positioning system (GPS) module. Further, the electronic control unit is configured to control an operation of the global positioning system module and to acquire position data from the global positioning system module. In a suitable configuration, position data from the GPS module can be transferred to a called external helper via the wireless telecommunication link, with obvious benefits.

In some embodiments, the car interior surveillance unit further comprises a temperature sensor that is arranged in the passenger cabin of the car. The electronic control unit is configured to control an operation of the temperature sensor and to acquire a temperature sensor signal. In this way, information on a temperature in the car passenger cabin can be transferred to a called external helper, which allows assessing the criticality of a potentially life-threatening situation. In some embodiments the car surveillance unit furthermore includes a far infrared thermal detector or imaging device. With this device further information about the criticality of a life threatening situation could be assessed.

In preferred embodiments, the electronic control unit is programmable via a wireless telecommunication link to the telecommunication unit. This can enable a convenient input or modification of control and operating parameters such as, but not limited to, a prioritized list of call codes (e.g. telephone numbers, internet addresses, . . . ) of remote telecommunication participants such as a mobile phone of the car owner or an emergency number, car brand, car model, car plate number, and a detection threshold of the detection means. Preferably, the wireless communication link for programming is established between the telecommunication unit and a remote telecommunication participant formed by a mobile phone, for instance a smartphone, or a tablet computer, which is furnished with a specific application software (mobile app). Furthermore a communication link may be configured for storing control data, operating parameters and/or surveillance data on a cloud based storage. In possible embodiments, the configuration of the device could be made via the cloud. In embodiments, the warning information could also be provided to the cloud for further processing.

In some embodiments, the car interior surveillance unit comprises an ultrasonic detector, and the electronic control unit is configured to operate the ultrasonic detector in a low-power consumption operating mode for anti-burglary purposes after a predetermined time period has elapsed,
if the electric power monitoring device has detected an absence of electric power at the electrical connection point for the predetermined time period, and
if the detection means of the detection unit has detected an absence of a living human being or a living animal being in the passenger cabin during the predetermined time period.

In this way, the ultrasonic detector may be used for anti-burglary protection after it has been ensured that no living human being or living animal being is present in the car passenger cabin. The ultrasonic detector may form the detection means of the detection unit. The ultrasonic detector may as well be distinct from the detection means of the detection unit.

It is another object of the invention to provide a method of operating the car interior surveillance unit. The method comprises steps of
monitoring a presence of electric power at the electrical connection point,
upon detecting a transition from a presence of electric power to an absence of electric power at the electrical connection point, transfer the detection unit and the telecommunication unit into an operational state, which is powered by the at least one rechargeable battery,
by the detection means, search a predetermined portion of the passenger cabin of the car for a presence of a living human being or a living animal being,
upon detecting presence of a living human being or a living animal being, establish a telecommunication link to a predetermined remote telecommunication participant by the telecommunication unit, and
transfer at least a predetermined set of information to the predetermined remote telecommunication participant.

A reliable method for detecting a presence of a living human being or a living animal in the passenger cabin of a locked car and for automatically calling external help in such cases can be provided in this way.

The step of monitoring a presence of electric power may be carried out in a continuous manner or may be carried out periodically for power saving purposes.

Detecting an absence of electric power at the electrical connection point usually is an indication of the car being in a locked state, and can be used as a trigger for activating the car interior surveillance unit and, in particular, for commencing the search for a presence of a living human being or a living animal being in the car passenger cabin.

Preferably, the step of searching the predetermined portion of the passenger cabin is carried out for a predetermined time period. After the time period has elapsed, at least the detection unit and the telecommunication unit are transferred into a standby mode.

In some embodiments of the method, the step of transferring at least a predetermined set of information includes a preceding step of requesting the set of information by the predetermined remote telecommunication participant via the established telecommunication link. In this way, a called external help, for example rescue workers, can decide on a priority of the information to be transferred on their own behalf, for instance in a case of a weak mobile network signal not allowing for a fast build-up of a camera view that is to be transferred.

In some embodiments of the method, the step of transferring at least a predetermined set of information includes transferring at least one out of
information representing a global position,
information representing a temperature of the car passenger cabin,
information representing an alarm/call for help,
information representing at least one photographic image of the car passenger cabin,
information representing a video stream of the passenger cabin, and
information representing a thermal image of the car passenger cabin or the occupant.

Furthermore, the predetermined set of information may comprise, but is not limited to, car brand, car model, car plate number and additional data from the detection unit, e.g. a signal level.

In some embodiments, the method comprises a step of storing data, generated or received by at least one out of the detection unit, the telecommunication unit and the electronic control unit, in the digital data memory unit.

Such data may be helpful in assessing the criticality of a potentially life-threatening situation. For instance, the timely development of the temperature rise in the car passenger cabin may be taken as an indication for the severity of the situation.

In another aspect of the invention, a software module for controlling an execution of steps of an embodiment of the method disclosed herein is provided.

The method steps to be conducted are converted into a program code of the software module, wherein the program code is implementable in a digital data memory unit of the car interior surveillance unit and is executable by a processor unit of the car interior surveillance unit. Preferably, the digital data memory unit and/or processor unit may be a digital memory unit and/or a processing unit of the electronic control unit. The processor unit may, alternatively or supplementary, be another processor unit that is especially assigned to execute at least some of the method steps.

The software module can enable a robust and reliable execution of the method and can allow for a fast modification of method steps.

### BRIEF DESCRIPTION OF THE DRAWINGS

Further details and advantages of the present invention will be apparent from the following detailed description of not limiting embodiments with reference to the attached drawing, wherein:

FIG. 1 is a schematic illustration of a car interior surveillance unit in accordance with the invention, installed in a passenger car,

FIG. 2 schematically illustrates a block diagram of the car interior surveillance unit pursuant to FIG. 1, and

FIGS. 3a, 3b show a flowchart of an embodiment of a method in accordance with the invention of operating the car interior surveillance unit pursuant to FIGS. 1 and 2.

### DESCRIPTION OF PREFERRED EMBODIMENTS

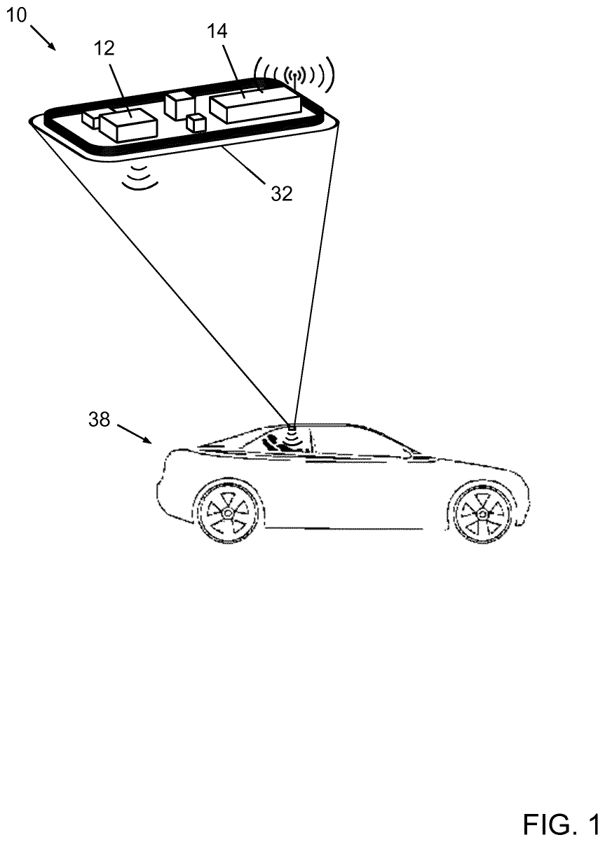

FIG. 1 schematically illustrates a car interior surveillance unit 10 in accordance with the invention in a state of being installed in a passenger car 38. The installation location is arranged at the interior roof top of the passenger car 38, utilizing the exact installation place at which a conventional rear interior light has originally been planned. Indeed, the car interior surveillance unit 10 has been installed by removing the illumination unit, designated brackets and cover lid of the convention rear interior light, and by replacing the conventional rear interior light by the car interior surveillance unit.

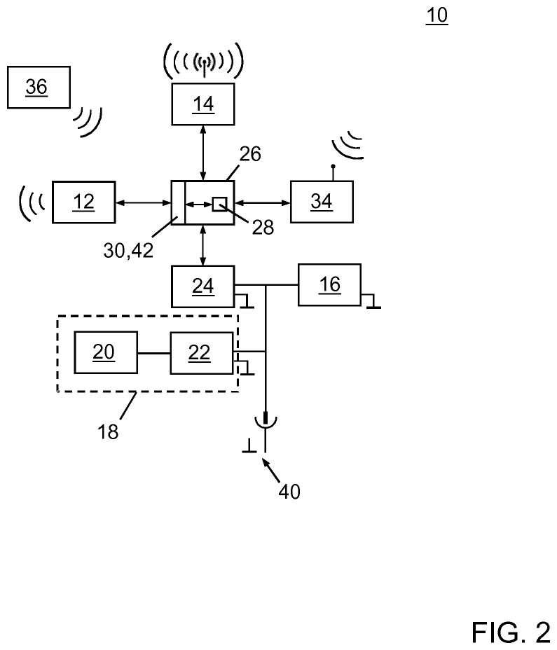

As the installation site had been originally intended for receiving a conventional rear interior light, it comprises an electrical connection point 40 (FIG. 2) of the on-board electrical voltage of the passenger car 38, and also a cavity that was planned for taking up an illumination unit and designated brackets of the conventional rear interior light. In this way, the electrical connection point 40 of the on-board electrical voltage of the passenger car 38 is formed by an electrical connection point 40 of the passenger car 38 that is intended to supply electric power to a conventional rear interior light arranged at the interior roof top of the passenger car.

FIG. 2 schematically illustrates a configuration of components of the car interior surveillance unit 10 pursuant to FIG. 1 in a block diagram. The car interior surveillance unit 10 comprises a detection unit 12, a telecommunication unit 14, an illumination unit 16 for serving as a rear interior light, an electric power supply unit 18, an electric power monitoring device 24 and an electronic control unit 26, all of which are mounted on a common carrier. The common carrier forms part of a housing 32 (FIG. 1) that completely covers the balance of the car interior surveillance unit 10 in the direction towards the car interior. The housing 32 has a mechanical interface (not shown) that is configured to mechanically engage with a corresponding mechanical interface (not shown) of the passenger car 38 arranged in the vicinity of the electrical connection point 40.

Moreover, the car interior surveillance unit 10 includes a global positioning system (GPS) module 34 and a temperature sensor 36 that is disposed at a suitable location in the passenger cabin of the car 38.

The detection unit 12 includes detection means formed by an emitter/detector combination using K-band radio waves for detecting the presence of a living human being or living animal being in the passenger cabin of the car 38. The housing 32 can be considered transparent for the K-band microwaves. Such radar detection means are known in the art and therefore need not be discussed in more detail herein.

The telecommunication unit 14 includes telecommunication means designed as a GPRS-compatible GSM module. The GSM module is able to establish a wireless telecommunication link to a remote telecommunication participant, and enables SMS (short message service) messaging and MMS (multimedia messaging service) communication.

The electric power supply unit 18 includes a rechargeable battery 20 and a battery charging unit 22 that is electrically connected to the electrical connection point 40 of the on-board electrical voltage of the passenger car 38 for charging the rechargeable battery 20 during times at which the electrical connection point 40 is energized (usually times of car driving). During times at which the electrical connection point 40 is not energized, which usually is an indication of the passenger car 38 being in a locked state, the rechargeable battery 20 is configured to provide electric power for operating the car interior surveillance unit 10, as will be described later on.

The electric power monitoring device 24 of the car interior surveillance unit 10 serves for monitoring a presence of electric power at the electrical connection point 40. Such devices are well known in the art and are therefore not discussed in more detail herein.

In this way, the rechargeable battery 20 is electrically connected to the electrical connection point 40 for charging purposes during times at which the electrical connection point 40 is energized. The car interior surveillance unit 10 can be powered by the rechargeable battery 20 during times at which the electrical connection point 40 is not energized.

For controlling operation of the detection unit 12 and the telecommunication unit 14, the car interior surveillance unit 10 comprises the electronic control unit 26. The electronic control unit 26 includes a processor unit 28 and a digital data memory unit 30 to which the processor unit 28 has data access. The electronic control unit 26 receives a signal from the electric power monitoring device 24. As will be described in the following, the electronic control unit 26 controls operation of the detection unit 12 and the telecommunication unit 14 on the basis of a detected absence of electric power at the electrical connection point 40 and a detected presence of a living human being or a living animal being in the passenger cabin.

The electronic control unit 26 is configured to control an operation of the GPS module 34 and to acquire position data from the GPS module 34. The electronic control unit 26 is also configured to acquire a signal of the temperature sensor 36. To this end, a Bluetooth® communication link is installed between the electronic control unit 26 and the temperature sensor 36.

In this specific embodiment of the car interior surveillance unit 10 the detection means are formed by a K-band microwave emitter/detector combination. In another embodiment (not shown), the car interior surveillance unit 10 may, as an alternative or in addition, include an ultrasonic detector. In that case, the electronic control unit may be configured to operate the ultrasonic detector in a low-power consumption operating mode for anti-burglary purposes if the following conditions are fulfilled:
a predetermined time period has elapsed (for example, a time period of five minutes),
the electric power monitoring device has detected an absence of electric power at the electrical connection point for the predetermined time period, and
the detection means (formed by at least one out of the K-band microwave emitter/detector combination and the ultrasonic detector) of the detection unit has detected an absence of a living human being or a living animal being in the passenger cabin during the predetermined time period.

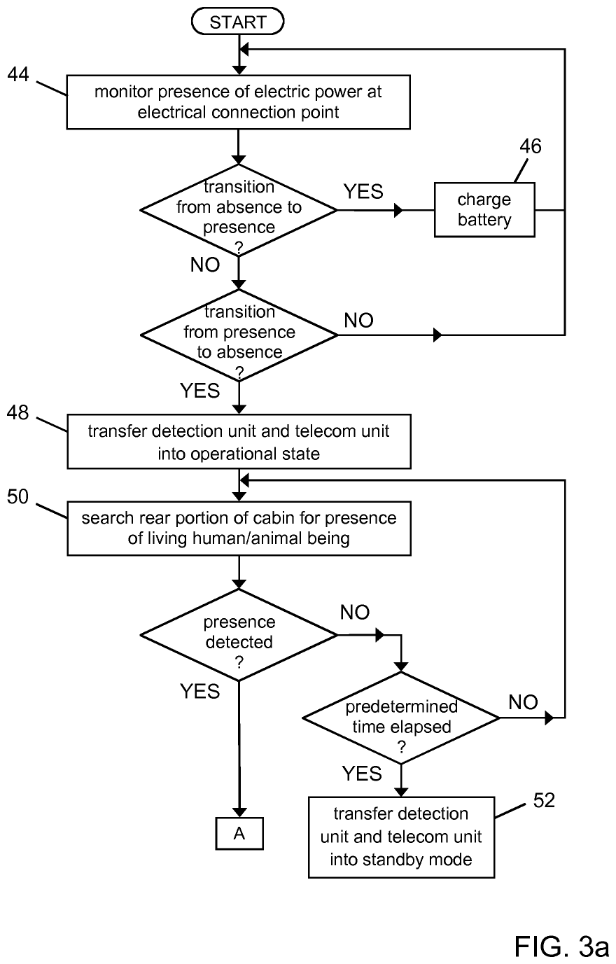

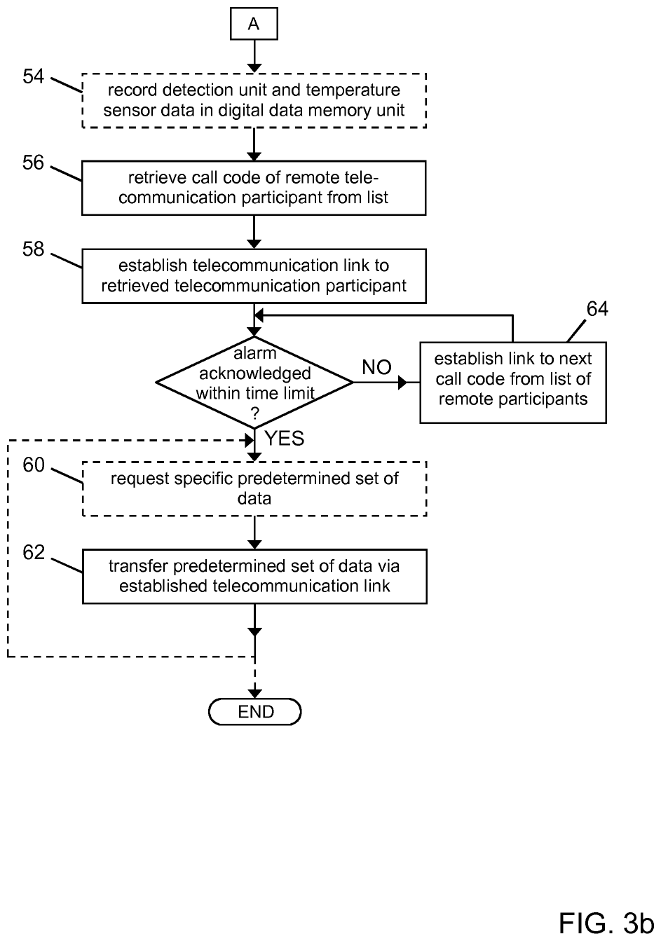

In the following, an embodiment of a method of operating the car interior surveillance unit 10 pursuant to FIGS. 1 and 2 will be described. A flowchart of the method is provided in FIGS. 3a and 3b. In preparation of operating the car interior surveillance unit 10, it shall be understood that all involved units and devices are in an operational state and configured as illustrated in FIGS. 1 and 2.

In order to control an automatic execution of steps of the method, the electronic control unit 26 comprises a software module 42 (FIG. 2). The method steps to be conducted are converted into a program code of the software module 42. The program code is implemented in the digital data memory unit 30 of the electronic control unit 26 and is executable by the processor unit 28 of the electronic control unit 26.

For the sake of description and without introducing any limitation, it shall be assumed that the passenger car 38 is in a locked state. In this situation, the detection unit 12 and the telecommunication unit 14 are in standby mode.

Referring to FIGS. 3a and 3b, in a first step 44 of the method, a presence of electric power at the electrical connection point 40 is periodically monitored by the electric power monitoring device 24.

Upon detecting a transition from an absence of electric power to a presence of electric power at the electrical connection point 40, as would occur when the passenger car 38 was unlocked, the rechargeable battery 20 is charged in a method step 46 via the battery charging unit 22 by the electric power provided at the electrical connection point 40.

Upon detecting a transition from a presence of electric power to an absence of electric power at the electrical connection point 40, as would occur when the passenger car 38 was locked, the detection unit 12 and the telecommunication unit 14 are transferred into an operational state by the electronic control unit 26 in another step 48.

In the next step 50 of the method, carried out by the detection means and controlled by the electronic control unit 26, a predetermined portion of the passenger cabin of the car 38, namely the rear portion including the rear bench, is quasi-continuously searched for a presence of a living human being or a living animal being. The search is carried out for a predetermined time period, for instance for a time period of five minutes. If this time period elapses without any presence of a living human being or living animal being detected by the detection unit 12, the detection unit 12 and the telecommunication unit 14 are controlled by the electronic control unit 26 back into standby mode in another step 52. It is noted that the employed detection means has been proven to detect a child even when it is sleeping.

Upon detecting presence of a living human being or a living animal being within the predetermined time, data generated by the detection unit 12 and the temperature sensor 36 may be recorded in the digital data memory unit 30 in an optional step 54, and a call code of a predetermined remote telecommunication participant is retrieved from a prioritized list of call codes that resides in the digital data memory unit 30 of the electronic control unit 26 in another step 56 of the method. Then, in the next step 58 a telecommunication link to the predetermined remote telecommunication participant with the retrieved call code (‘retrieved telecommunication participant’) is established by the telecommunication unit 14, controlled by the electronic control unit 26.

In this specific example, the first predetermined remote telecommunication participant in the list of call codes is a mobile phone of the car owner. The second predetermined remote telecommunication participant in the list of call codes is a national emergency number (for example 110 or 911). The order of call codes of predetermined remote telecommunication participants in the list can readily be modified at a user's discretion, and could be different in a different embodiment of the method.

The prioritized list of call codes of predetermined remote telecommunication participants can conveniently be inputted to the car interior surveillance unit 10 or modified, using a wireless Bluetooth® link. Control and operating parameters of the car interior surveillance unit 10 can readily be set or modified in this way, using a specific mobile application software installed on the mobile phone of the car owner. In this specific embodiment, control and operating parameters include, besides the prioritized list of call codes of telecommunication participants, a detection threshold of the detection means for detecting a presence of a living human being or a living animal and information regarding car brand, car model and car color, and the car plate number. The inputted control and operating parameters reside in the digital data memory unit 30 of the electronic control unit 26.

It will be appreciated, that a communication link may also be configured for storing control data, operating parameters and/or surveillance data on a cloud based storage. In possible embodiments, the configuration of the device could be made via the cloud. In embodiments, the warning information could also be provided to the cloud for further processing.

In another step 62 then, a predetermined set of information is transferred to the predetermined remote telecommunication participant via the established telecommunication link. In this specific example, the step 62 of transferring the predetermined set of information includes transferring information representing an alarm, a temperature value of the car passenger cabin from the temperature sensor, retrieved by the electronic control unit 26, and a global position, also retrieved by the electronic control unit 26 from the GPS module 34. The predetermined set of information is transferred via the established telecommunication link as an SMS message.

Using the specific mobile application software that is installed on the mobile phone, the car owner can send, in an optional step 60 preceding the step 62 of transfer, a request for another specific predetermined set of information to be transferred via the established telecommunication link. By way of example, the car owner can send a request for transferring recorded data from the detection unit 12 to exclude a false alarm caused by hardware malfunction.

If the alarm message is not acknowledged within a predetermined time period of, for example, one minute, another telecommunication link is established to the call code of the second predetermined remote telecommunication participant of the list of call codes of remote telecommunication participants in a next step 64, and a modified predetermined set of information is transferred to the second predetermined remote telecommunication participant as step 62. The modified predetermined set of information includes, in addition to the first predetermined set of information, information on car brand, car model, car color, and car plate number.

While the invention has been illustrated and described in detail in the drawings and foregoing description, such illustration and description are to be considered illustrative or exemplary and not restrictive; the invention is not limited to the disclosed embodiments.

Other variations to be disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting scope.

### LIST OF REFERENCE SYMBOLS

10 car interior surveillance unit
12 detection unit
14 telecommunication unit
16 illumination unit
18 electric power supply unit
20 rechargeable battery
22 battery charging unit
24 electric power monitoring device
26 electronic control unit
28 processor unit
30 digital data memory unit
32 housing
34 GPS module
36 temperature sensor
38 passenger car
40 electrical connection point
42 software module

steps:
44 monitor presence of electric power
46 charge rechargeable battery
48 transfer units into operational state
50 search passenger cabin portion
52 transfer units into standby mode
54 record data
56 retrieve predetermined telecommunication participant
58 establish telecommunication link
60 request specific data
62 transfer predetermined set of information
64 establish 2^{nd} telecommunication link

1. A car interior surveillance unit, comprising
a detection unit including detection means for detecting a presence of a living human being or a living animal being in the passenger cabin of a car,
a telecommunication unit including telecommunication means for establishing a wireless telecommunication link to a remote telecommunication participant,
an electric power supply unit including
at least one rechargeable battery for providing electric power in at least one operational mode of the car interior surveillance unit,
a battery charging unit that is electrically connectable to an electrical connection point of the on-board electrical voltage of the car for charging the at least one rechargeable battery,
an electric power monitoring device for monitoring a presence of electric power at the electrical connection point, and
an electronic control unit that includes a processor unit and a digital data memory unit and that is configured for controlling operation of at least the detection unit and the telecommunication unit at least on the basis of
a detected absence of electric power at the electrical connection point, and
a detected presence of a living human being or a living animal being in the passenger cabin.

2. The car interior surveillance unit as claimed in claim 1, further comprising
an illumination unit, for serving as an interior light, which is connectable to the electrical connection point of the on-board electrical voltage of the car,
a housing for at least partially covering the balance of the car interior surveillance unit towards the car interior, wherein the housing has a mechanical interface that is configured to mechanically engage with a corresponding mechanical interface arranged in the vicinity of the electrical connection point.

3. The car interior surveillance unit as claimed in claim 2, wherein said illumination unit is configured to emit light in the visible spectrum and/or in the infrared spectrum into the passenger cabin.

4. The car interior surveillance unit as claimed in claim 2, wherein the electrical connection point of the on-board electrical voltage of the car is formed by an electrical connection point of the car that is intended to supply electric power to a conventional rear interior light arranged at the interior roof top of the car.

5. The car interior surveillance unit as claimed in claim 1, further comprising a global positioning system module, wherein the electronic control unit is configured to control an operation of the global positioning system module and to acquire position data from the global positioning system module.

6. The car interior surveillance unit as claimed in claim 1, further comprising a temperature sensor that is arranged in the passenger cabin of the car, wherein the electronic control unit is configured to control an operation of the temperature sensor and to acquire a temperature sensor signal.

7. The car interior surveillance unit as claimed in claim 1, wherein the electronic control unit is programmable via a wireless telecommunication link to the telecommunication unit.

8. The car interior surveillance unit as claimed in claim 1, comprising an ultrasonic detector, wherein the electronic control unit is configured to operate the ultrasonic detector in a low-power consumption operating mode for anti-burglary purposes after a predetermined time period has elapsed
if the electric power monitoring device has detected an absence of electric power at the electrical connection point for the predetermined time period, and
if the detection means of the detection unit has detected an absence of a living human being or a living animal being in the passenger cabin during the predetermined time period.

9. A method of operating the car interior surveillance unit as claimed in claim 1, the method comprising steps of
monitoring a presence of electric power at the electrical connection point,
upon detecting a transition from a presence of electric power to an absence of electric power at the electrical connection point, transfer the detection unit and the telecommunication unit into an operational state, which is powered by the at least one rechargeable battery,
by the detection means, search a predetermined portion of the passenger cabin of the car for a presence of a living human being or a living animal being,
upon detecting presence of a living human being or a living animal being, establish a telecommunication link to a predetermined remote telecommunication participant by the telecommunication unit, and
transfer at least a predetermined set of information to the predetermined remote telecommunication participant.

10. The method as claimed in claim 9, wherein the step of transferring at least a predetermined set of information includes a preceding step of requesting the set of information by the predetermined remote telecommunication participant via the established telecommunication link.

11. The method as claimed in claim 9, wherein the step of transferring at least a predetermined set of information includes transferring at least one out of
information representing a global position,
information representing a temperature of the car passenger cabin,
information representing an alarm/call for help,
information representing at least one photographic image of the car passenger cabin,
information representing a video stream of the passenger cabin, and
information representing a thermal image of the car passenger cabin or the occupant.

12. The method as claimed in claim 9, comprising a step of storing data generated or received by at least one out of the detection unit, the telecommunication unit and the electronic control unit in the digital data memory unit.

13. A non-transitory computer-readable medium for controlling an execution of steps of the method as claimed in claim 9, wherein the method steps to be conducted are represented by a program code stored on the computer-readable medium, wherein the program code is executable by a processor unit of the electronic control unit or a separate control unit.
